(19) United States
(12) Patent Application Publication
(10) Pub. No.: US 2011/0176497 A1
(43) Pub. Date: Jul. 21, 2011

(54) INTER-CELL INTERFERENCE COORDINATION AND POWER CONTROL SCHEME FOR DOWNLINK TRANSMISSIONS

(76) Inventor: NANDU GOPALAKRISHNAN, Madison, NJ (US)

(21) Appl. No.: 12/690,609

(22) Filed: Jan. 20, 2010

(51) Int. Cl. H04W 72/12; H04W 52/04

(52) U.S. Cl. 370/329; 455/522

(57) ABSTRACT

The present invention provides a method involving a first base station serving a first cell. The first base station neighbors one or more second base stations that serve one or more second cells. The method includes boosting power transmitted by the first base station in a first sub-band of a frequency band available for transmission and reducing power transmitted by the first base station in a second sub-band of the frequency band available for transmission. The first and second sub-bands are different. The method also includes scheduling resources, using a scheduler in the first base station, for transmission at the boosted power in the first sub-band and the reduced power in the second sub-band based on signal-to-interference-plus-noise (SINR) ratios associated with the first and second sub-bands.

### BACKGROUND OF THE INVENTION

1. Field of the Invention

This invention relates generally to communication systems, and, more particularly, to wireless communication systems.

2. Description of the Related Art

Wireless communication systems typically include a plurality of base stations or access points that provide wireless connectivity to mobile units within a geographical area that is usually referred to as a cell. The air interface between the base station or access point and the mobile unit supports one or more downlink (or forward link) channels from the base station to the mobile unit and one or more uplink (or reverse link) channels from the mobile units to the base station. The uplink and/or downlink channels include traffic channels, signaling channels, broadcast channels, paging channels, pilot channels, and the like. The channels can be defined according to various protocols including time division multiple access (TDMA), frequency division multiple access (FDMA), code division multiple access (CDMA), orthogonal frequency division multiple access (OFDMA), as well as combinations of these techniques. The geographical extent of each cell may be time variable and may be determined by the transmission powers used by the base stations, access point, and/or mobile units, as well as by environmental conditions, physical obstructions, and the like.

Mobile units are assigned to base stations or access points based upon properties of the channels of supported by the corresponding air interface. For example, in a traditional cellular system, each mobile unit is assigned to a serving cell on the basis of criteria such as the uplink and/or downlink signal strength. The mobile unit then communicates with the serving cell over the appropriate uplink and/or downlink channels. Signals transmitted between the mobile unit and the serving cell may interfere with communications between other mobile units and/or other cells. For example, mobile units and/or base stations create intercell interference for all other sites that use the same time/frequency resources. The increasing demand for wireless communication resources has pushed service providers towards implementing universal resource reuse (which is also referred to as re-use factor 1 or full re-use). Systems that implement universal re-use allow each cell to distribute available transmission power across the entire available spectrum/bandwidth. Consequently, universal re-use increases the likelihood of intercell interference. In fact, the performance of modern systems is primarily limited by intercell interference, which dominates the underlying thermal noise and leads to reduced throughput and/or increased packet loss.

The downlink intercell interference experienced by a mobile unit depends, at least in part, on the location of the mobile unit within the cell. For example, mobile units that are located closer to the center of the cell (e.g., closer to the serving base station for the cell) tend to experience lower levels of intercell interference because they are typically farther from the centers of adjacent cells. Mobile units that are located near the edge of the cell (e.g., further from the serving base station for the cell) typically experience higher levels of intercell interference because they are closer to the base stations serving the adjacent cells. Moreover, mobile units that are very near the edge of the cell are likely be close to or in handoff with one or more adjacent cells and therefore they may experience roughly comparable relative downlink signal strengths from the serving cell and the adjacent cells.

Conventional wireless communication systems have implemented techniques to mitigate the inter cell interference problem. For example, interference can be mitigated by adopting “partial reuse” or “reuse factor N, N>1” in a cluster of neighboring cells. The available time and frequency resources are divided up between the cells in the cluster and each cell is given the exclusive right to use the allocated portion of the time and frequency resources. A geographic region can be tiled by numerous clusters that constitute a “reuse pattern”. Partial re-use increases the “reuse distance” between transmitters employing a particular time and frequency resource and improves the signal to interference+noise ratio (SINR) since the interference strength decays rapidly with distance from the transmitter of the interfering signal. However, partial re-use also leads to lowered spectral efficiency per unit area (bits per second per hertz per square km). This type of solution has been historically adopted in AMPS (analog FDMA), digital GSM and TDMA networks and more recently in orthogonal frequency division multiple access (OFDMA) mobile networks such as IEEE 802.16 (WIMAX) and LTE.

The interference can also be averaged using “spread spectrum” techniques that spread the interference power across the available bandwidth via “direct sequence spreading” or “frequency hopping.” The interfering signal can also be accumulated across several transmission instances to reduce its variance across the transmit resource units used for the intended signal to make the interfering signal resemble Gaussian noise, which conventional transmission and reception techniques are typically designed to combat. This type of solution is most common in CDMA (although frequency hopping is used in GSM and TDMA mainly) networks such as IS 95, 3G1X family (including EVDO), UMTS/WCDMA.

Power control can also be used to reduce interference. Power control interference reduction techniques operate on the basic principle that each transmitter should use just enough transmit power to overcome wireless channel impairments such as propagation path loss, fading, irreducible interference, thermal noise, and the like so that the transmitted signal can be received with a sufficient level of net SINR to allow for its reception and decoding at the desired fidelity. Power control interference reduction techniques therefore require that the transmitter receive some estimate of the net channel impairment. Open loop power control uses measurements by a co-located receiver for the opposite link to make an estimate of the transmit power (with typically slow updates due to the longer time window to average out inaccuracies due to link asymmetry). In closed loop power control. a receiver at one end of a link estimates the channel conditions and sends feedback commands indicating any increase or decrease in the transmitter power. Fast power control is essential for CDMA (3G1X, UMTS/WCDMA) with fixed rate operation (e.g. voice) to combat the ‘near-far problem’ of the non-orthogonal uplink and is also used to complement variable discrete rate control operation (e.g. scheduled packet data) besides augmenting the downlink where transmit power is a shared resource. Power control is also used to complement interference avoidance techniques in GSM and TDMA systems.

Other interference mitigation techniques include interference nulling and interference cancellation. Antenna (spatial) schemes can be used for interference nulling (e.g. SDMA). For example, antenna array phasing techniques can be used to steer a null of the synthesized pattern in the direction of dominant interferers. Spatial degrees of freedom available may also be exploited with appropriate receiver techniques and transmission aids to convert a stream of interference into a parallel stream of data in multi-user MIMO. Multi-user detectors (with the possibility of superposition coding for downlink) can be used for interference cancellation to enhance capacity especially in interference limited digital systems such as CDMA, although it could also be applied to orthogonal access systems such as OFDMA for partial mitigation of other cell interference. However, interference cancellation requires considerably higher receiver complexity than other techniques.

### SUMMARY OF THE INVENTION

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a method is provided involving a first base station serving a first cell. The first base station neighbors one or more second base stations that serve one or more second cells. The method includes boosting power transmitted by the first base station in a first sub-band of a frequency band available for transmission and reducing power transmitted by the first base station in a second sub-band of the frequency band available for transmission. The first and second sub-bands are different. The method also includes scheduling resources, using a scheduler in the first base station, for transmission at the boosted power in the first sub-band and the reduced power in the second sub-band based on signal-to-interference-plus-noise (SINR) ratios associated with the first and second sub-bands.

In another embodiment, a method is provided for coordinating downlink transmissions in a plurality of adjacent cells. The method includes partitioning users in each of the cells into at least one center user and at least one edge user. The method also includes partitioning a spectrum allocated to each of the plurality of adjacent cells into a first portion and a second portion such that the second portion of the spectrum of each of the plurality of adjacent cells differs from the second portion of the spectrum of the other adjacent cells. The method further includes transmitting to the center user(s) in the first portion at a first power and transmitting to the edge user(s) in the second portion and a second power that is larger than the first power.

In yet another embodiment, a method is provided for coordinating downlink transmissions. The method includes forming, at a server, one or more clusters including a first cell and one or more second cells neighboring the first cell. The method includes determining, at the server, a fraction of a total downlink bandwidth that is less than or equal to an inverse of a number of cells in the cluster(s). The method also includes transmitting, from the server to the first cell and the second cell(s), instructions to increase a power spectral density for downlink transmissions in a first sub-band having the determined fraction of the total downlink bandwidth and instructions to the decrease a power spectral density for downlink transmissions in a second sub-band having the remainder of the total downlink bandwidth. The first sub-bands used by the first cell and the second cells are different.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates one exemplary embodiment of a wireless communication system;

FIG. 2 conceptually illustrates one exemplary embodiment of a downlink spectrum and power allocation; and

FIG. 3 conceptually illustrates one exemplary embodiment of a cell.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Generally speaking, the present application describes embodiments of an inter-cell interference coordination (ICIC) scheme that utilizes downlink power control. Some ICIC schemes are “partial” reuse schemes where limited reuse of the spectrum resource is applied in a “hard” manner on a fraction (as opposed to all) of a cell's coverage region/served users or “soft” manner via power spectral density shaping over the spectrum resource with varying degrees of coordination across a cluster of cells in a network. One version of ICIC is uplink fractional frequency reuse (UL FFR), which applies partial reuse to users transmitting from parts of the cell (e.g., users at the cell borders or edge) that ordinarily cause a large amount of interference to ‘disadvantaged’ users in neighboring cells, e.g., users near the edge of the neighboring cells.

Partial reuse can increase the reuse distance between cell edge users in neighboring cells that ordinarily impact each other adversely. Users in the remaining regions of the cell (e.g., at the cell interior) that do not have significant adverse impact on their neighbors can utilize the entire bandwidth (full reuse). Alternatively, in the “inverted” version of UL FFR, part of the available spectrum is set aside in each cell as a “trash heap.” Edge users in each cell do not use the trash heap portion of the available spectrum so that edge users in adjacent cells can transmit with high powers without worry of causing interference. Preventing transmission by edge users in the trash heap portion of the transmission spectrum of the cell containing the edge user can reduce interference in adjacent cells. For example, an edge user in one cell could transmit in the trash heap band of its nearest neighbor cell without worrying that the transmissions will collide or interfere with transmissions from edge users in neighboring cells.

Intercell interference coordination schemes can also be applied over the downlink. For example, the transmitter power allocated to a base station for downlink transmissions to a first cell can be “notched” down by several dB within a narrow slice of the allocated frequency spectrum. Thus, the downlink transmission is essentially switched off in the notched portion of the frequency spectrum so that communication between the base station and edge users in the first cell is essentially blocked (or severely curtailed) in the notched region. Consequently, the notched region is constrained to be a small fraction of the available bandwidth to avoid significant reductions in throughput in the first cell. Edge users in adjacent (second) cells can receive downlink transmissions from base stations that serve the adjacent second cell(s) in the notched-down sub-band without worry of interference from the first cell. Transmissions to edge users in the first cell can be scheduled in un-notched sub-bands of the first cell, which may be in notched or trash heap sub-band of the adjacent nearest neighbor cells, without worry of strong interference from the nearest neighbor cells.

The present application describes embodiments of a multi-cell coordinated partial and soft fractional reuse scheme for downlink operation. Coordination of the cells in a cluster may be static (time invariant) or may alternatively permit semi-static or fully dynamic adaptation with (optionally) accompanying inter cell co-ordination to traffic distributions. These techniques can be combined with downlink power control to distribute the total available power from the power amplifier across sub-bands of the downlink transmission spectrum to form a power spectral density (p.s.d.) profile that is shaped differently from the conventional “straight line” uniform power spectral density. Soft methods may involve power spectral density (p.s.d.) shaping of transmissions over the available spectrum resource within a network of cells. The p.s.d patterns can be static or alternatively be adapted semi-statically or dynamically. Embodiments of the non-uniform p.s.d. profile described herein could therefore be static or may alternatively be slowly time varying to adapt to changing traffic distributions, environmental conditions, and the like. Creation of the p.s.d. patterns could be fully centralized or distributed with limited exchange of information between cells or autonomous.

The multi-cell coordinated partial and soft fractional reuse scheme described herein implements direct partial reuse in which a relatively narrow portion of the spectrum is cleared for privileged use by a particular cell in a cluster. Operation of neighboring cells is coordinated so that the cleared portion of the spectrum is different for adjacent cells. A non-uniform power spectral density profile is applied in the remaining portions of the spectrum of the cells. Base stations in each of the cells can then boost the transmission power spectral density in the privileged portion of the spectrum and correspondingly reduce the power spectral density in the remaining portions of the spectrum. Edge users are preferentially allocated resources in the privileged portion of the spectrum and interior users are preferentially allocated resources in the de-boosted portion of the spectrum. Since edge users typically experience lower downlink signal-to-interference-plus-noise ratios, their net throughput increases approximately linearly with increasing power spectral density. In contrast, interior users are typically bandwidth limited and so their net throughput increases only approximately logarithmically with increasing power spectral density. However, interior users experience linear improvement with increasing bandwidth.

Coordination of the downlink transmissions using the non-uniform our spectral density described herein can therefore improve the performance of the communication system. For example, increasing the bandwidth of the common sub-band can compensate for the potential decrease in throughput to the interior users caused by de-boosting the power spectral density in the common sub-band. At the same time, edge users are pushed into the relatively narrower cleared sub-band where the increase in power spectral density can overcome the potential decrease in throughput caused by the narrower bandwidth in the cleared sub-band. In some embodiments, both the net throughput of the edge users and the interior users simultaneously increase, resulting in an increase in the average throughput. The performance of the edge users (e.g., the 5^{th} percentile edge throughput) can therefore be improved relative to the conventional uniform power spectral density configuration (e.g., equal power density over the downlink spectrum and reuse 1 in the cell cluster) via partial reuse and power boost without compromising average throughput. Alternatively, average cell throughput may be increased without compromising edge throughput.

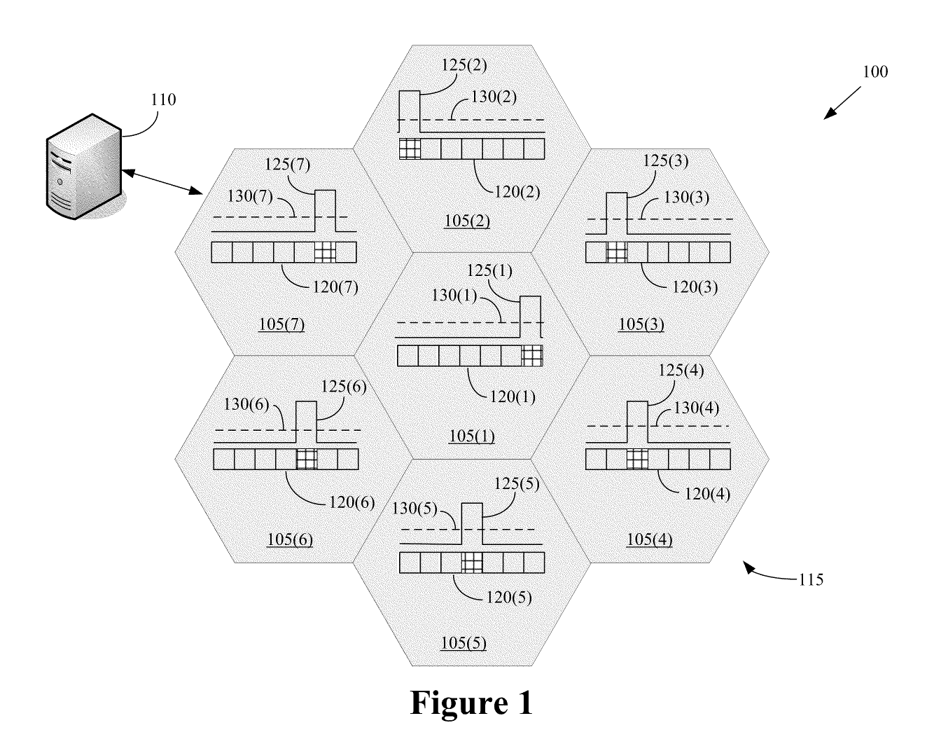

FIG. 1 conceptually illustrates one exemplary embodiment of a wireless communication system 100. In the illustrated embodiment, the wireless communication system 100 includes a plurality of cells 105 (or sectors). In the interest of clarity, the cells 105 depicted in FIG. 1 are idealized hexagons that have regular, constant, and sharp boundaries. However, persons of ordinary skill in the art having benefit of the present disclosure should appreciate that boundaries the cells are typically determined by pilot power strengths of pilot signals transmitted by the cells (or base stations therein). Variations in the pilot signal strength, angular distribution of the transmitted signal, adaptive beamforming of the transmitted signal, environmental conditions, man-made and/or natural obstacles, and the like can influence the actual shape of a sector or cell 105. Actual cells 105 may therefore have irregular shapes, may vary in time, and may not have sharp boundaries so that the different cells 105 may overlap in some regions.

The cells 105 are communicatively coupled to one or more servers 110 or other devices that are used to coordinate operation of the cells 105. For example, the server 110 may be connected to base stations, base station routers, and or other access points within the cells 105 over networks including various wired and/or wireless communication links. Techniques for establishing, maintaining, and utilizing communication links between the server 110 and the cells 105 are known in the art and in the interest of clarity only those aspects of establishing, maintaining, and/or utilizing the communication links that are relevant to the claimed subject matter will be discussed in detail herein. The server 110 may include hardware, firmware, and/or software that are used to implement embodiments of the inter-cell interference coordination and power control techniques described herein.

Each cell 105 can be grouped into a cluster that includes the cell 105 and its nearest neighbors. In the illustrated embodiment, the cell 105(1) is a part of a cluster 115 that includes the cell 105(1) and the adjacent or nearest neighbor cells 105(2-7). The cluster 115 therefore includes seven cells 105. However, persons of ordinary skill in the art having benefit of the present disclosure should appreciate that alternative embodiments may include clusters that have more or fewer cells. Furthermore, the number of cells in any given cluster may change, e.g., in response to varying environmental conditions that changes the number of nearest neighbor cells. Similar clusters (not shown in FIG. 1) can be formed for other cells 105 within the wireless communication system and the clusters can be tiled over the entire coverage area served by the wireless communication system 100. In one embodiment, the pattern of cell clusters 115 is predetermined and can be communicated to the cells 105 via the server 110 or other entity within the wireless communication system. Alternatively, the server 110 can determine the clustering pattern (either statically or dynamically) and convey information indicating the clustering pattern to the cells 105 as necessary.

In the illustrated embodiment, the cells 105 are configured to transmit downlink signals in a selected bandwidth or spectrum of frequencies. The frequencies used for downlink transmission by the cells 105 are assumed to be the same for all the cells 105 in the embodiment shown in FIG. 1. However, persons of ordinary skill in the art having benefit of the present disclosure should appreciate that alternative embodiments may include cells 105 that transmit using different downlink frequency ranges. A part of the spectrum, e.g. a sub-band, used by each cell is cleared for operation at low interference. For example, the server 110 may determine the frequency range of the cleared sub-band for each cell 105 and then communicate information indicating the allocation/selection of the cleared sub-band to each of the cells 105. The frequency range of the cleared sub-band is confined to a fraction of the total spectrum that can be determined by the reuse factor implemented in the particular embodiments. If K is the reuse factor, (K−1) proximate neighbor sectors may each be allocated similar but distinct pieces of cleared spectrum that partition the whole spectrum. Cleared spectrum is frequency diverse in the illustrated embodiment and in some cases this can be achieved by forming the cleared spectrum of physically discontiguous segments of the spectrum. Consequently, the cleared sub-band should have a bandwidth that is approximately 1/K times the bandwidth of the downlink transmission spectrum. For example, cleared sub-bands allocated to the cells 105 should have a bandwidth that is less than or substantially equal to 1/7 of the bandwidth of the downlink transmission spectrum allocated to the cells 105.

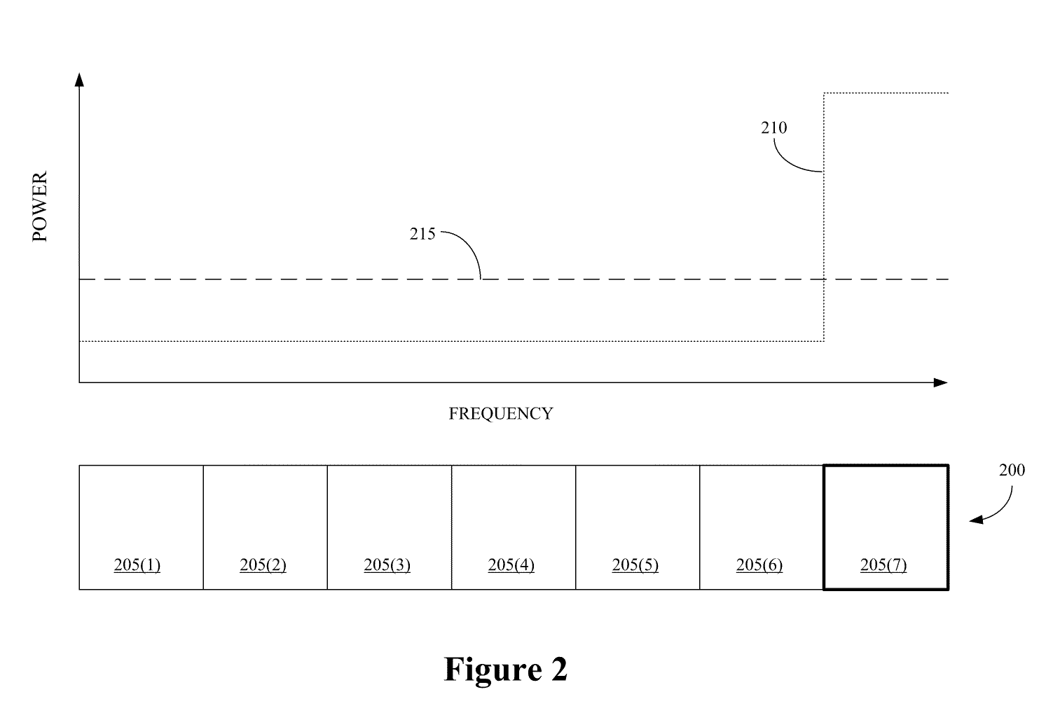

FIG. 2 conceptually illustrates one exemplary embodiment of a downlink spectrum 200. In the illustrated embodiment, the downlink spectrum 200 is partitioned into a plurality of sub-bands 205. The bandwidth of each of the sub-bands 205 is equal in the illustrated embodiment, although persons of ordinary skill in the art having benefit of the present disclosure should appreciate that this is not necessary for the practice of the techniques described herein. Furthermore, each of the sub-bands 205 may be used to support any number of channels having any desirable channel bandwidths. The downlink spectrum 200 shown in FIG. 2 is divided into seven sub-bands 205 and may therefore be suitable for use in the wireless communication system 100 depicted in FIG. 1. The sub-band 205(7) has been selected as the cleared sub-band, as indicated by the bold outline of the box indicating the sub-band 205(7).

Referring back to FIG. 1, selection of the cleared sub-bands for each of the cells 105 can be done in a coordinated way across the cells 105 in the cluster 110 using “cell coloring” or “frequency planning” methods. The cleared sub-bands are selected so that the adjacent cells 105 are allocated cleared sub-bands in different frequency ranges. In the illustrated embodiment, the downlink spectra 120 allocated to each cell 105 are divided into seven sub-bands. The sub-bands allocated to each cell 105 are indicated by cross-hatching and have been allocated to each cell 105 so that adjacent cells 105 do not use the same cleared sub-band. For example, the cell 105 has been allocated the right-most sub-band in the spectrum 120(1) to use as the cleared sub-band and the adjacent cell 105(2) has been allocated the left-most sub-band in the spectrum 120(2) to use as the cleared sub-band. In one embodiment, the allocation of the sub-bands to the cells 105 may be predetermined and transmitted to the cells 105 via the server 110. Alternatively, the server 110 can determine the sub-band allocation (either statically or dynamically) and transmit information indicating the allocated sub-bands to the cells 105.

Each sector or cell 105 applies a non-uniform power spectral distribution to distribute the total available transmission power. As shown in FIG. 2, the power spectral density 210 in the cleared sub-bands 205(7) is increased relative to the uniform power spectral distribution 215 for the same total available transmission power. The power spectral density 210 in the common sub-bands 205(1-6) is reduced or de-boosted relative to the uniform power spectral distribution 215. For example, the increase in the cleared sub-band 205(7) and the decrease in the common sub-bands 205(1-6) may be selected to maintain the same total available transmission power. In one embodiment, code rates (for QPSK) could optionally be limited to the mother code rate (⅓) as is done in HSPA to compress bandwidth effectively in the cleared sub-band 205(7). By coordinating the cleared sub-bands in the spectra 120, the power spectral density 125 is boosted (relative to the uniform power spectral density 130) in different sub-bands for adjacent cells 105. Although the uniform power spectral density 130 is depicted as being the same in the cells 105, alternative embodiments may be scaled to different overall powers and therefore different comparison values of the uniform power spectral densities 130. The specific shape and amplitude of the power spectral densities 125 may also vary between the cells 105.

Users in the cells 105 are aggregated or collected into classes that include interior users and edge users. The edge users may be preferentially scheduled within the cleared sub-band and interior users may be preferentially scheduled within a common sub-band that includes all of the sub-bands that have not been cleared. Classification of the users into classes may be explicit or implicit. Explicit classification includes techniques for classifying the users based upon measured qualities of the uplink and/or downlink communication channels. Implicit classification includes techniques for scheduling users based on channel quality indication (CQI) feedback metrics and/or SINR feedback metrics from the users and the criterion that the scheduler is designed to optimize, such as end-user throughput and/or overall cell throughput. As will be discussed in detail herein, the scheduler may preferentially schedule edge users for transmission in the cleared sub-band; thereby implicitly classifying these users as edge users.

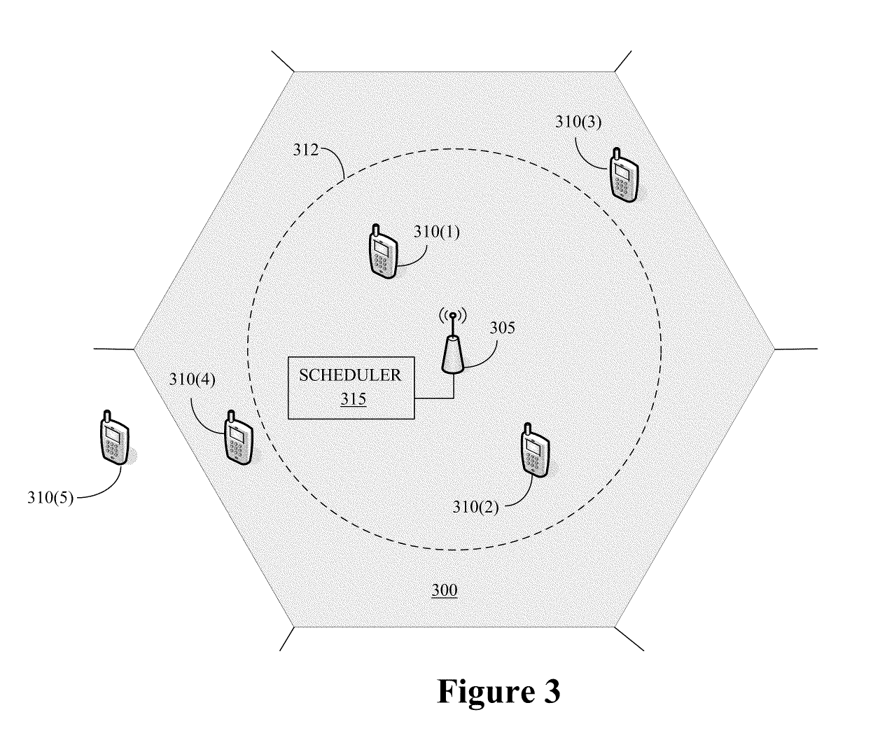

FIG. 3 conceptually illustrates one exemplary embodiment of a cell 300. In the illustrated embodiment, the cell 300 includes a base station 305 that can categorize or classify mobile units 310 as edge users and/or interior users. Classification of the mobile units 310 can be performed on a semi-static timescale, e.g., a period over which the traffic distribution is essentially stationary within some specified tolerance and/or limit. In the illustrated embodiment, mobile units 310(1-2) that are inside the boundary 312 are considered interior users and the mobile units 310(3-4) that are outside the boundary 312 are considered edge users. Preferentially scheduling edge users into the cleared and power-boosted sub-bands can reduce interference with downlink communications to users in adjacent cells such as the mobile unit 310(5). Classification of the users may be performed explicitly prior to scheduling the users or implicitly as a part of the scheduling process.

One example of an explicit classification technique uses downlink channel quality to classify edge users and interior users. In this technique, the base station 305 can access various measures of the downlink channel quality that are reported by each of the mobile units 310. Exemplary measures may include but are not limited to post-processed measurements such as semi-statically averaged downlink SINR (CQI) or path loss (dB). The measures of the downlink channel quality can then be compared against a threshold to determine whether the mobile unit 310 is an edge user or interior user. For example, a path loss difference between strongest neighbor and serving cell or serving cell path gain can be compared against a threshold T (e.g., in linear range of Shannon capacity in the case of DL SINR). The value of the threshold T can be cell specific or a system wide tunable parameter. If the value of the measurement >T, then the user is labeled as interior. Otherwise, it is labeled as edge.

Another example of an explicit classification technique also uses reported measurements. However, in this exemplary technique, the base station 305 orders or ranks mobile units 310 that are attached to a given sector according to one of the above measurements (e.g., the mobile units 310 can be ordered according to their DL SINR). If the mobile units 310 are ranked or listed in descending order of their channel quality measure, then the first x-th percentile of mobile units 310 may be considered interior users and the remaining as edge users. In some embodiments, a maximum limit (e.g. 50% of all users in the cell) may be further imposed on either or both of the number of interior users and number of edge users to improve robustness of the algorithm.

Implicit classification of the mobile units 310 into edge users and interior users may be performed when the base station 305 schedules the mobile units 310. In one embodiment, the base station 310 includes a scheduler 315 that prioritizes each user on a sub-band basis (e.g., a frequency selective basis) based on some criterion or underlying utility function such as the signal-to-interference-plus-noise ratio (SINR) or channel quality information (CQI) for each sub-band. Operation of the scheduler 315 can therefore implicitly classify the mobile units 310 because of the different power spectral densities in the cleared and common sub-bands. In some embodiments, the CQI metrics reported by each user in each sub-band may be scaled, for example, if the numerator of the DL SINR or CQI was based on pilot reference symbols that were not boosted/de-boosted and the denominator of the CQI includes sub-band specific interference. The information about the power profile in the scheduler's cell and neighboring cells (interference profile) can be captured in the scaled CQI metric and passed on to the scheduler 315 which then properly accounts for this in the downlink transmission schedule. Consequently, it is highly likely that edge users are scheduled in the cleared sub-band and interior users are scheduled in the common sub-band.

For example, the scheduler 315 may implement a proportional fair scheduling algorithm that attempts to allocate channels of comparable channel qualities (e.g., SINR and/or CQI) to each mobile unit 310. As discussed herein, the cleared sub-band in each cell has a higher power spectral density than the common sub-bands, which implies that users of scheduled in the cleared sub-bands can receive higher signal strength and the users scheduled in the common sub-bands. The higher signal strength can compensate for higher interference and/or noise. Consequently, mobile units 310 located in less advantageous areas (such as edge users that experience higher levels of interference and/or noise) that are scheduled in the cleared sub-band may have comparable SINR values to mobile units 310 located in more advantageous areas (such as interior users that experience lower levels of interference and noise) that are scheduled in the common sub-bands. The scheduler 315 automatically schedules the edge users and interior users in this manner so that the edge users and the interior users have comparable channel quality measures such as SINR and/or CQI when the different power spectral densities are used in the different sub-bands.

Referring back to FIG. 1, the server 110 (or other entity in the wireless communication system 100) can determine the appropriate boosting/de-boosting parameters to increase cell throughput per unit bandwidth subject to a constraint that gains for edge users remain at least substantially comparable to gains for edge users for the comparison case of uniform power transmission in the first and second sub-bands. In one embodiment, the power spectral density in the cleared spectrum can be boosted with respect to the power spectral density φ^{eq} of a baseline equal power spectral density and reuse 1 (EQR1) by a factor of αK, where the parameter αε[0,1] is a fairness control parameter. One exemplary selection of the fairness control parameter is to set the fairness control parameter to a value of α≧1/K, where K is the reuse parameter. To conserve the total downlink transmission power δP, where P is the power budget for the cell 105, the deboost factor δ for partial direct re-use and power control (PDRPC) in the common spectrum is:

$$β = \frac{( δ - α ) K}{( K - 1 )}$$

The parameter δε(0,1], ( [symbol] αε(0, δ) is a utilization control parameter that can be used as an additional tuning knob for partial loading to reduce interference

In one embodiment, the downlink transmission control parameters can be selected based on lumped user Shannon theory-based maximization techniques. Low SINR users (at edge) operate in the linear (with respect to SINR) region of the Shannon capacity. Thus bandwidth decreased operation with respect to the reuse 1 comparison case can be compensated by a proportional increase in the power spectral density with respect to the comparison case of uniform power spectral density φ^{eq}. Low SINR users have diminishing returns with coding (bandwidth expansion) as incremental coding gain becomes smaller and smaller and the diminishing returns approach zero as bandwidth W increases. Since the low SINR (edge) users are basically power limited, capacity improvement in this region is due to additional energy per channel use and/or interference reduction. In contrast, high SINR users (at center) operate in the logarithmic region (concave increasing) with respect to SINR and the linear region with respect to bandwidth. The reduction in the throughput caused by reducing the power spectral density (with respect to the comparison case of uniform power spectral density φ^{eq}) can therefore be compensated by the bandwidth expansion offered by the common spectrum. High SINR users have slowing returns with energy increase and even these returns saturate in practical systems with limited modulation order and SM degrees of freedom. Since the high SINR users are essentially bandwidth limited, capacity improvement in this region is due to bandwidth increase such as the increase that results when the interior users are able to take up bandwidth vacated by edge users.

Assuming the lumped user approximation, the problem of selecting the boosting/de-boosting parameters that maximize PDPC sector throughput per unit bandwidth subject to an edge throughput constraint of non-negative dB gain with respect to the comparison case of uniform spectral density and reuse factor 1 (EQR1) can be formulated as follows:

$$( {α}^{*} , {δ}^{*} ) = arg {max}_{δ ∈ ( 0 , 1 ] , α ∈ [ \frac{( ( K - 1 ) + δ {KI}_{0 e} / {N}_{0} ) ( 1 - {λ}_{c} )}{( K - 1 ) + ( ( 2 - {λ}_{c} ) K - 1 ) {I}_{0 e} / {N}_{0}} , δ ]} ( \begin{matrix}α ( K - 1 ) \frac{{φ}^{eq} {γ}_{e} / {N}_{0}}{\begin{matrix}( K - 1 ) + \\ ( δ - α ) {KI}_{0 e} / {N}_{0}\end{matrix}} + \\ \frac{( K - 1 )}{K} {log}_{2} \\ ( 1 + \frac{( δ - α ) K}{( K - 1 )} \frac{{φ}^{eq} {γ}_{c} / {N}_{0}}{( 1 + α {KI}_{0 c} / {N}_{0} )} )\end{matrix} )$$

where

$$\frac{{I}_{0 e}}{{N}_{0}}$$

is the lumped edge user interference relative to thermal in EQR1,

$$\frac{{I}_{0 c}}{{N}_{0}}$$

is the lumped interior user interference relative to thermal in EQR1,

$$\frac{{φ}^{eq} {γ}_{e}}{{N}_{0}}$$

is the lumped edge user received SNR (signal to thermal noise ratio) and

$$\frac{{φ}^{eq} {γ}_{c}}{{N}_{0}}$$

is the lumped center user received SNR under uniform power spectral density. In one embodiment, the server 110 can implement this methodology to make the power boost/de-boost parameter choices. The parameter selections can be made statically and/or dynamically and then transmitted to the cells 105, which may then configure themselves to implement the selected parameter choices.

Embodiments of the techniques described herein have a number of advantages over conventional operations such as the comparison case of uniform power spectral density and reuse factor 1. For example, the signal power spectral density of edge users transmitting in the cleared sub-band of each cell or sector is boosted and interference power spectral density from proximate neighbors on a sector's or cell's cleared sub-band (to edge users) may be reduced. Average bandwidth occupied by edge users is typically reduced and the bandwidth savings can be transferred to interior users resulting in their higher bandwidth occupancy With proper choice of design parameters (reuse factor, power boost factor, interior to edge user ratio etc.) both edge user throughput and interior user throughput can be concurrently increased. Alternatively, edge user throughput or interior user throughput can be raised without compromising the other. Clamping design parameters within maximum and/or minimum limits may help provide robust performance with no significant losses in either edge user throughput, interior user throughput, or average cell/sector throughput.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method involving a first base station serving a first cell, the method comprising:
boosting power transmitted by the first base station in a first sub-band of a frequency band available for transmission;
reducing power transmitted by the first base station in a second sub-band of the frequency band available for transmission; and
scheduling resources, using a scheduler associated with the first base station, for transmission at the boosted power in the first sub-band and the reduced power in the second sub-band based on signal-to-interference-plus-noise (SINR) ratios associated with the first and second sub-bands.

2. The method of claim 1, wherein the first base station neighbors at least one second base station that serves at least one second cell, and wherein each of said at least one second base stations boosts power in a corresponding first sub-band of the frequency band available for transmission such that the first sub-bands associated with the first base station and said at least one second sub-band differ from each other.

3. The method of claim 2, wherein each of said at least one second base stations schedules resources, using a scheduler in the corresponding second base station, in its first and second sub-bands based on signal-to-interference-plus-noise (SINR) ratios associated with its first and second sub-bands.

4. The method of claim 2, wherein each of said at least one second base stations preferentially allocates resources in its boosted first sub-band to users that are within and closer to an edge of said at least one second cell served by each second base station.

5. The method of claim 1, wherein each of the said first and second sub-bands are logical entities that comprise frequency diverse units of spectrum.

6. The method of claim 1, comprising selecting a bandwidth of the first sub-band and a bandwidth of the second sub-band.

7. The method of claim 6, wherein selecting the bandwidth of the first sub-band comprises selecting a fraction of the frequency band available for transmission that is less than or substantially equal to an inverse of a number of neighboring second cells plus one, and wherein selecting the bandwidth of the second sub-band comprises selecting the remainder after the first sub-band is subtracted from the frequency band available for transmission.

8. The method of claim 7, wherein boosting power transmitted by the first base station in the first sub-band comprises boosting a power spectral density in the first sub-band to be larger than an equal power spectral density for uniform power transmission over the entire frequency band available for transmission.

9. The method of claim 8, wherein reducing power transmitted by the first base station in the second sub-band comprises reducing a power spectral density in the second sub-band to be less than the equal power spectral density for uniform power transmission over the entire frequency band available for transmission.

10. The method of claim 9, wherein boosting the power spectral density in the first sub-band comprises boosting the power spectral density in the first sub-band to increase cell throughput per unit bandwidth subject to a constraint that gains for edge users remain at least substantially comparable to gains for edge users for uniform power transmission in the first and second sub-bands.

11. The method of claim 1, wherein scheduling the resources using the scheduler in the first base station comprises preferentially allocating resources in the boosted first sub-band to at least one edge user that is within and closer to an edge of said at least one first cell.

12. The method of claim 11, wherein scheduling the resources comprises explicitly partitioning users in the first cell into a class of said edge users and a complementary class of non-edge or center users that are within and closer to the center of said at least one first cell based on at least one of:
a proximity of each user in the first cell to an edge of the first cell;
a proximity of each user in the first cell to center of the first cell;
a relative radio path loss difference for each user in the first cell, the relative radio path loss difference being measured between the first cell and a nearest neighbor cell; or
a signal-to-interference-plus-noise ratio for each user in the first cell that is determined assuming a uniform power spectral density in the first cell and all neighbor cells.

13. The method of claim 12, wherein scheduling the resources comprises explicitly allocating resources in the first sub-band to the edge users and resources in the second sub-band to the center users.

14. A method of coordinating downlink transmissions in a plurality of adjacent cells, comprising:
partitioning a spectrum allocated to each of the plurality of adjacent cells into a first portion and a second portion such that the second portion of the spectrum of each of the plurality of adjacent cells differs from the second portion of the spectrum of the other adjacent cells; and
transmitting to at least one center user in the first portion at a first power and transmitting to at least one edge user in the second portion at a second power that is larger than the first power.

15. The method of claim 14, comprises partitioning users into edge users and center users based on proximity of each user to the edge of a cell containing the user.

16. The method of claim 14, wherein partitioning the spectrum into the first portion and the second portion comprises:
selecting a first portion that includes a fraction of the spectrum that is less than or substantially equal to an inverse of a number of neighboring cells plus one; and
selecting a second portion that includes a remainder after the first portion is subtracted from the spectrum.

17. The method of claim 14, wherein transmitting to said at least one center user in the first portion at the first power comprises transmitting to said at least one center user at a reduced power spectral density relative to an equal power spectral density for uniform power transmission over the spectrum.

18. The method of claim 17, wherein transmitting to said at least one edge user in the second portion at the second power comprises transmitting to said at least one edge user at an increased power spectral density relative to the equal power spectral density for uniform power transmission over the spectrum.

19. The method of claim 18, wherein transmitting to said at least one edge user in the second portion at the second power comprises transmitting to said at least one edge user at the increased power spectral density to increase cell throughput per unit bandwidth subject to a constraint that gains for edge users remain at least substantially comparable to gains for edge users for uniform power transmission over the spectrum.

20. A method of coordinating downlink transmissions comprising:
determining, at a server, a fraction of a total downlink bandwidth that is less than or equal to an inverse of a number of cells in at least one cluster including a first cell and at least one second cell neighboring the first cell;
transmitting, from the server to the first cell and said at least one second cell, instructions to increase a power spectral density for downlink transmissions in a first sub-band having the determined fraction of the total downlink bandwidth and decrease a power spectral density for downlink transmissions in a second sub-band having the remainder of the total downlink bandwidth.

21. The method of claim 20, wherein transmitting instructions to increase the power spectral density in the first sub-band and decrease the power spectral density in the second sub-band comprises transmitting instructions to increase the power spectral density in the first sub-band and decrease the power spectral density in the second sub-band while maintaining a selected total downlink transmission power.

22. The method of claim 20, comprising determining the power spectral density for downlink transmissions in the first sub-band.

23. The method of claim 22, wherein determining the power spectral density for downlink transmissions in the first sub-band comprises determining the power spectral density to increase cell throughput per unit bandwidth subject to a constraint that gains for edge users remain at least substantially comparable to gains for the edge users for uniform power transmission over the spectrum.

24. The method of claim 20, wherein determining the power spectral density for downlink transmissions in the first sub-band comprises dynamically determining the power spectral density for downlink transmissions in the first sub-band concurrently with operations of the first cell and said at least one second cell.
